(19) United States
(12) Patent Application Publication
(10) Pub. No.: US 2023/0169383 A1
(43) Pub. Date: Jun. 1, 2023

(54) METHODS AND SYSTEMS FOR QUANTUM COMPUTATIONAL CHEMISTRY MODELING

(71) Applicant: Texas Tech University System, Lubbock, TX (US)

(72) Inventor: Lionel W. Poirier, Lubbock, TX (US)

(21) Appl. No.: 17/918,512

(22) PCT Filed: Apr. 12, 2021
(86) PCT No.: PCT/US2021/026924

§ 371 Date: Oct. 12, 2022

Related U.S. Application Data
(60) Provisional application No. 63/009,425, filed on Apr. 13, 2020.

(51) Int. Cl. G06N 10/20; G06F 17/16

(52) U.S. Cl. CPC G06N 10/20; G06F 17/16

(57) ABSTRACT

Methods and systems for simulating performance of quantum computational chemistry comprise representing wavefunctions using a Cartesian component-separated tensor-product, representing the Hamiltonian using a Cartesian component-separated tensor-product, and computing resultant energy eigenvalues and eigenstate wavefunctions of the Hamiltonian for one or more quantum states, with a classical computer. Methods and system for quantum computational chemistry comprise establishing the representation of a physical system, representing the initial wavefunction, representing the Hamiltonian using a Cartesian com-ponent-separated tensor-product, and computing the time evolved wavefunction.

### CROSS REFERENCE TO RELATED PATENT APPLICATION

This patent application claims the priority and benefit, under 35 U.S.C. § 119(e), of U.S. Provisional Patent Application Ser. No. 63/009,425, filed Apr. 13, 2020, and titled “METHODS AND SYSTEMS FOR QUANTUM COMPUTATIONAL CHEMISTRY MODELING”. U.S. Provisional Application Ser. No. 63/009,425 is incorporated herein by reference in its entirety.

### TECHNICAL FIELD

Embodiments are generally related to the field of quantum computing. Embodiments are further related to the field of computational modeling. Embodiments are also related to the field of quantum computational modeling. Embodiments are further related to quantum computational chemistry. Embodiments are also related to quantum eigensolvers. Embodiments are also related to modeling quantum mechanical states of electrons, nuclei, and other particles in molecules using numerical simulations.

### BACKGROUND

Quantum computing represents the most promising frontier for a wide range of computational problems that even the most advanced “classical” computers cannot solve. Many industry leaders are investing heavily in quantum computing. One of the challenges associated with quantum computing is that coding for a quantum computer is very difficult and generally, not well understood.

A classical computer is coded in bits, where information is stored as a series of states, either 0 or 1. A quantum computer's fundamental information unit is the “qubit”. With a qubit, states are not restricted to just 0 or 1, but can encompass many possible probabilistic “superpositions.”

“Quantum chemistry” is an industry term that usually refers to modeling electronic structure in, for example, individual molecules or in chemical reactions. “Electronic structure” may indicate the discrete energy levels that are allowed by the laws of quantum physics, as well as the associated quantum electronic states. However, the term “quantum chemistry” has also been extended to encompass calculations of the quantum states associated with nuclear motion. Computing quantum states reliably, accurately, in the full-dimensional problem space, and with many states provided for each given system remains a difficult problem requiring presently unavailable computing power.

Quantum computing holds tremendous potential but, to date, has been limited by the complexities associated with stable, reliable and scalable quantum hardware, and nonintuitive constraints on software, or coding. As such, there is a need in the art for improved methods and systems for modeling quantum mechanical states of electrons (and nuclei) in molecules using numerical simulations implemented on quantum computers. The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

### SUMMARY

In one embodiment, the systems and methods disclosed herein are directed to a new process, by which accurate simulations of quantum computational chemistry (i.e., quantum chemistry calculations run on a quantum computer) may be obtained on a classical computer. The process involves: first, using a grid-based plane-wave-dual representation of the quantum state “wavefunctions” in full explicit dimensionality, as will be used in long-term quantum computing; second, using a highly compact Cartesian component-separated tensor-product expansion for both the wavefunctions and the potential energy; and third, using an efficient, machine-learning-based, tensor-product algorithm to compute multiple (both ground and excited state) quantum energy levels, eigenstate wavefunctions, and correlation functions. This provides detailed information not only about accurate numerical results that should be expected on a quantum computer (with rigorous error bars), but also important performance information such as the dependence of the computed accuracy on the grid size per dimension—which, for a quantum computer, can be translated into the required number of qubits. Moreover, the process can also be used to estimate the required number of quantum gates (i.e., the quantum computing analog of logic gates in classical computing).

In another embodiment, the disclosed methods and systems represent a means for accomplishing bona-fide long-term (first-quantized) quantum computational chemistry (i.e. running on a quantum computer). The method involves: first, using the above grid-based representation on a quantum computer; second, using the above Cartesian component-separated tensor-product expansion for the potential energy; third using the disclosed methods and quantum circuits to compute the resultant quantum energy levels, etc. In another embodiment, the disclosed methods and systems can be used to compute the time-evolution of the wavefunction.

In an embodiment, a method for simulating performance of quantum computational chemistry, comprises representing wavefunctions using a Cartesian component-separated tensor-product, representing the Hamiltonian using a Cartesian component-separated tensor-product, and computing resultant energy eigenvalues and eigenstate wavefunctions of the Hamiltonian for one or more quantum states, with a classical computer.

In certain embodiments of the method for simulating performance of quantum computational chemistry, representing wavefunctions using a Cartesian component-separated tensor-product further comprises representing wavefunctions using a Cartesian component-separated tensor-product on a plane-wave-dual grid. In certain embodiments of the method for simulating performance of quantum computational chemistry, representing the Hamiltonian using a Cartesian component-separated tensor-product further comprises representing the Hamiltonian using a Cartesian component-separated tensor-product on a plane-wave-dual grid.

In certain embodiments of the method for simulating performance of quantum computational chemistry, determining the number of qubits required for a commensurate calculation with a quantum computer and determining the number of quantum gates required for a commensurate calculation with a quantum computer.

In certain embodiments of the method for simulating performance of quantum computational chemistry comprises using the resultant energy eigenvalues to predict an expected output from a commensurate calculation with a quantum computer, using the resultant eigenstate wavefunctions to predict an expected output from a commensurate calculation with a quantum computer, and using correlation functions obtained from the eigenstate wavefunctions, to predict an expected output from a commensurate calculation with a quantum computer.

In certain embodiments of the method for simulating performance of quantum computational chemistry, computing resultant energy eigenvalues and eigenstate wavefunctions of the Hamiltonian for one or more quantum states, with a classical computer, further comprises establishing optimal component-separated basis sets. In certain embodiments of the method for simulating performance of quantum computational chemistry, computing resultant energy eigenvalues and eigenstate wavefunctions of the Hamiltonian for one or more quantum states, with a classical computer, further comprises determining tensor-product Hamiltonian-wavefunction matrix-vector products. In certain embodiments of the method for simulating performance of quantum computational chemistry, computing resultant energy eigenvalues and eigenstate wavefunctions of the Hamiltonian for one or more quantum states, with a classical computer, further comprises applying (block) Krylov iteration to generate new Krylov vectors. In certain embodiments of the method for simulating performance of quantum computational chemistry, computing resultant energy eigenvalues and eigenstate wavefunctions of the Hamiltonian for one or more quantum states, with a classical computer, further comprises projecting the Hamiltonian onto the Krylov vectors. In certain embodiments of the method for simulating performance of quantum computational chemistry, computing resultant energy eigenvalues and eigenstate wavefunctions of the Hamiltonian for one or more quantum states, with a classical computer, further comprises band-pass staging.

In certain embodiments of the method for simulating performance of quantum computational chemistry, the wavefunctions comprise a Cartesian component-separated tensor product of the form

$$ψ \approx {\sum }_{λ = 1}^{Γ} {X}^{λ} ( {x}_{1} , {x}_{2} , … {x}_{N} ) {Y}^{λ} ( {y}_{1} , {y}_{2} , … {y}_{N} ) {Z}^{λ} ( {z}_{1} , {z}_{2} , … {z}_{N} ) .$$

In certain embodiments of the method for simulating performance of quantum computational chemistry, the one-particle and two-particle potential energy contributions to the Hamiltonian comprise Cartesian component-separated tensor products of the form

$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$

respectively.

In another embodiment, a method for performing first-quantized quantum computational chemistry comprises establishing the representation of a physical system, representing the initial wavefunction |ψ(0) [symbol] , representing the Hamiltonian using a Cartesian component-separated tensor-product, and computing the time evolved wavefunction |ψ(t) [symbol] =Û(t)|ψ(0) [symbol] .

In an embodiment of the method for performing first-quantized quantum computational chemistry, computing the time evolved wavefunction |ψ(t) [symbol] =Û(t)|ψ(0) [symbol] further comprises computing resultant energy eigenvalues and eigenstate wavefunctions of the Hamiltonian for one or more quantum states, with a quantum computer.

In an embodiment of the method for performing first-quantized quantum computational chemistry, the representation of the physical system is a plane-wave-dual grid-based representation comprising coordinate grid spacing, minimum and maximum coordinate values, and a number of grid points. In an embodiment of the method for performing first-quantized quantum computational chemistry, the kinetic energy is represented in a plane-wave basis representation, the potential energy is represented in component-separated tensor-product form in a plane-wave-dual grid-based representation, and the initial wavefunction |ψ(0) [symbol] is represented in a plane-wave-dual grid-based representation.

In an embodiment of the method for performing first-quantized quantum computational chemistry, the one-particle and two-particle potential energy contributions to the Hamiltonian comprise Cartesian component-separated tensor products of the form

$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$

respectively.

In an embodiment of the method for performing first-quantized quantum computational chemistry, applying the Quantum Phase Estimation algorithm provides a ground state energy level and eigenstate wavefunction. In an embodiment of the method for performing first-quantized quantum computational chemistry, applying the Quantum Phase Estimation algorithm provides excited state energy levels and eigenstate wavefunctions.

In an embodiment of the method for performing first-quantized quantum computational chemistry, computing the time evolved wavefunction |ψ(t) [symbol] =Û(t)|ψ(0) [symbol] further comprises applying a sequence of Û(ε)|ψ [symbol] operations with a small time step ε, using the Trotter approximation. In certain embodiments of the method for performing first-quantized quantum computational chemistry, the one-particle and two-particle potential energy contributions to the Trotter approximation, exp(−iε\hat{V}ₑₓₜ)|ψ₁ [symbol] and exp(−iε\hat{V}ₑₑ)|ψ₁₂ [symbol] , respectively, are implemented using a Cartesian component-separated tensor-product quantum circuit.

In another embodiment, an apparatus comprises quantum hardware, the quantum hardware further comprising a quantum system comprising one or more qubits, and one or more control devices configured to operate the quantum system wherein the apparatus is configured to perform operations comprising: establishing the representation of a physical system, representing the initial wavefunction |ψ(0) [symbol] , representing the Hamiltonian using a Cartesian component-separated tensor-product, and computing the time evolved wavefunction |ψ(t) [symbol] =Û(t)|ψ(0) [symbol] .

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 illustrates a computer software system for directing the operation of the data-processing system depicted in FIG. 1, in accordance with an example embodiment;

FIG. 4A depicts a quantum computational chemistry modeling system, in accordance with the disclosed embodiments;

FIG. 4B depicts another embodiment of a quantum computational modeling system in accordance with the disclosed embodiments;

FIG. 5 depicts steps associated with a method for simulating quantum computational chemistry on a classical computer, in accordance with the disclosed embodiments;

FIG. 6 depicts steps associated with the Cartesian component-separated tensor-product eigensolve methodology, in accordance with the disclosed embodiments;

FIG. 7 depicts steps associated with a method for conducting quantum computational chemistry on a quantum computer, in accordance with the disclosed embodiments;

FIG. 8 illustrates the overall quantum circuit used to implement Û(ε)|ψ [symbol] on a quantum computer in accordance with the disclosed embodiments;

FIG. 9 illustrates a standard quantum circuit in accordance with the disclosed embodiments; and

FIG. 10 illustrates a quantum circuit associated with a quantum computer, using the Cartesian component-separated tensor-product form, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

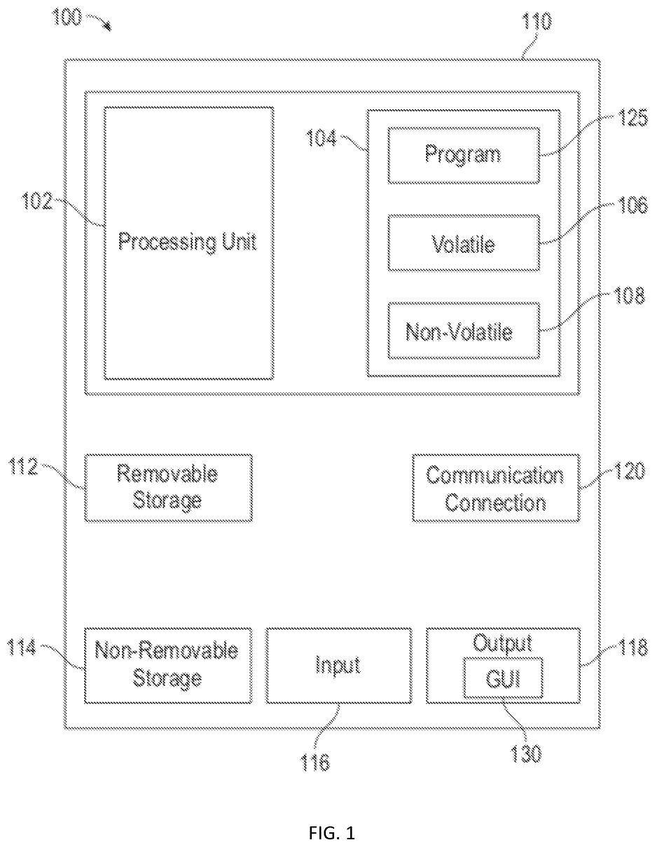

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with controllers, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

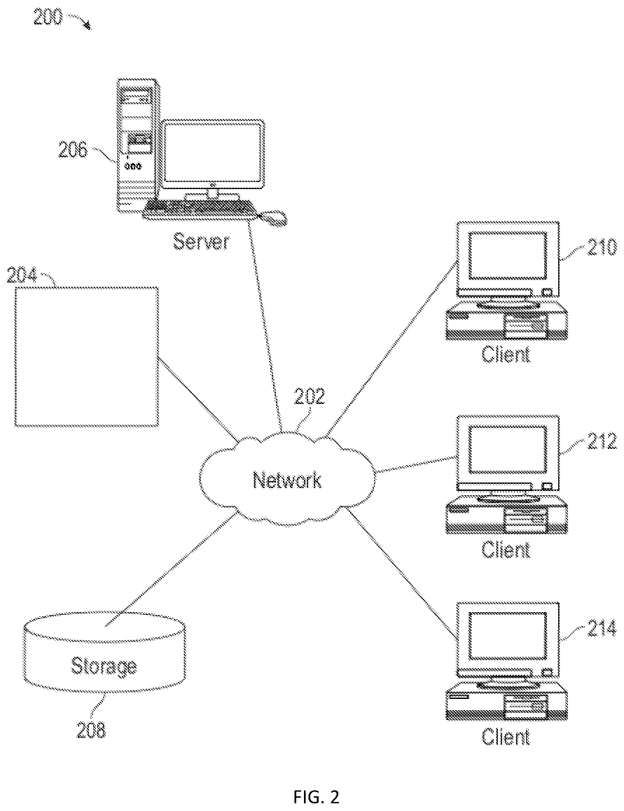

Computer 110 may include, or have access to, a computing environment that includes input 116, output 118, and a communication connection 120. The computer may operate in a networked environment using a communication connection 120 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse, and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 can be a network of computers or other such devices, such as mobile phones, smart phones, sensors, controllers, speakers, tactile devices, and the like, in which embodiments of the present invention may be implemented. Note that the system 200 can be implemented in the context of a software module such as program module 125. The system 200 includes a network 202 in communication with one or more clients 210, 212, and 214. Network 202 may also be in communication with one or more devices 204, servers 206, and storage 208. Network 202 is a medium that can be used to provide communications links between various devices and computers connected together within a networked data processing system such as computer system 100. Network 202 may include connections such as wired communication links, wireless communication links of various types, and fiber optic cables. Network 202 can communicate with one or more servers 206, one or more external devices such as device 204, and a memory storage unit such as, for example, memory or database 208. It should be understood that device 204 may be embodied as a quantum computer as disclosed herein.

In the depicted example, device 204, server 206, and clients 210, 212, and 214 connect to network 202 along with storage unit 208. Clients 210, 212, and 214 may be, for example, personal computers or network computers, handheld devices, mobile devices, tablet devices, smart phones, personal digital assistants, printing devices, recording devices, speakers, MFDs, etc. Computer system 100 depicted in FIG. 1 can be, for example, a client such as client 210 and/or 212 and/or 214.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet, with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

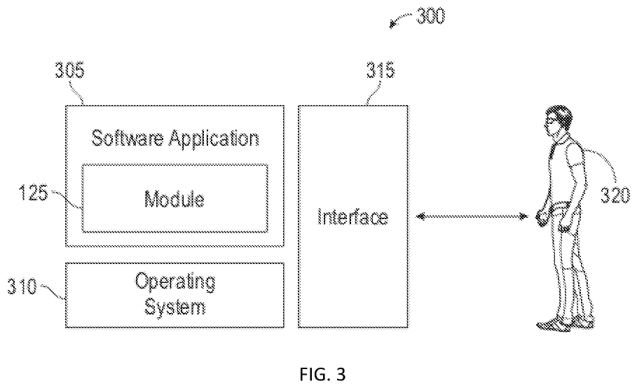

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of, a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of systems and application software. Moreover, the present invention may be embodied on a variety of different platforms, including Windows, Macintosh, UNIX, LINUX, Android, Arduino and the like on the classical computing side, using any number of standard programming languages and libraries (C++, Matlab, python, etc.). On the quantum computing side, the present invention may encompass any manner or combination of quantum hardware, quantum libraries, and quantum programming languages and scripts, including quantum libraries for standard classical computing languages, and languages, libraries, and hardware developed in conjunction with specific commercial platforms and various open-source efforts, such as, but not limited to: QSage, QMASM (D-Wave); Cirq, OpenFermion-Cirq (Google); QISKit, QASM (IBM); Q # (Microsoft); Forest, Grove, QAOA (Rigetti); Blackbird, Strawberry Fields (Xanadu); OpenFermion, ProjectQ (open source). Therefore, the descriptions of the exemplary embodiments, which follow, are for purposes of illustration and not considered a limitation.

In order to achieve “quantum supremacy” in the arena of quantum computational chemistry, there is a need for systems and associated methods that require as few qubits and quantum gates as possible. Additionally, because currently available quantum hardware is unreliable, there is demand for classical computing tools that can provide both (i) realistic quantum computational requirements, and (ii) the correct output, for cutting-edge benchmark quantum chemistry applications.

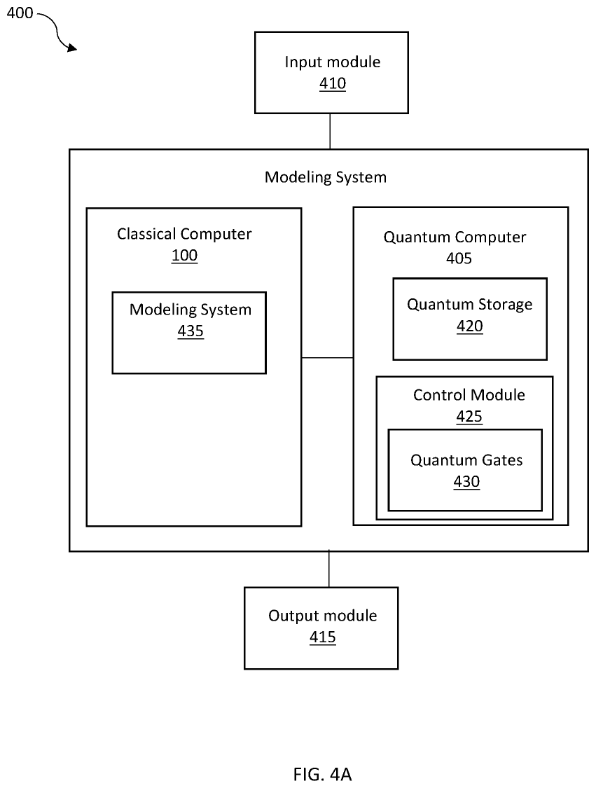

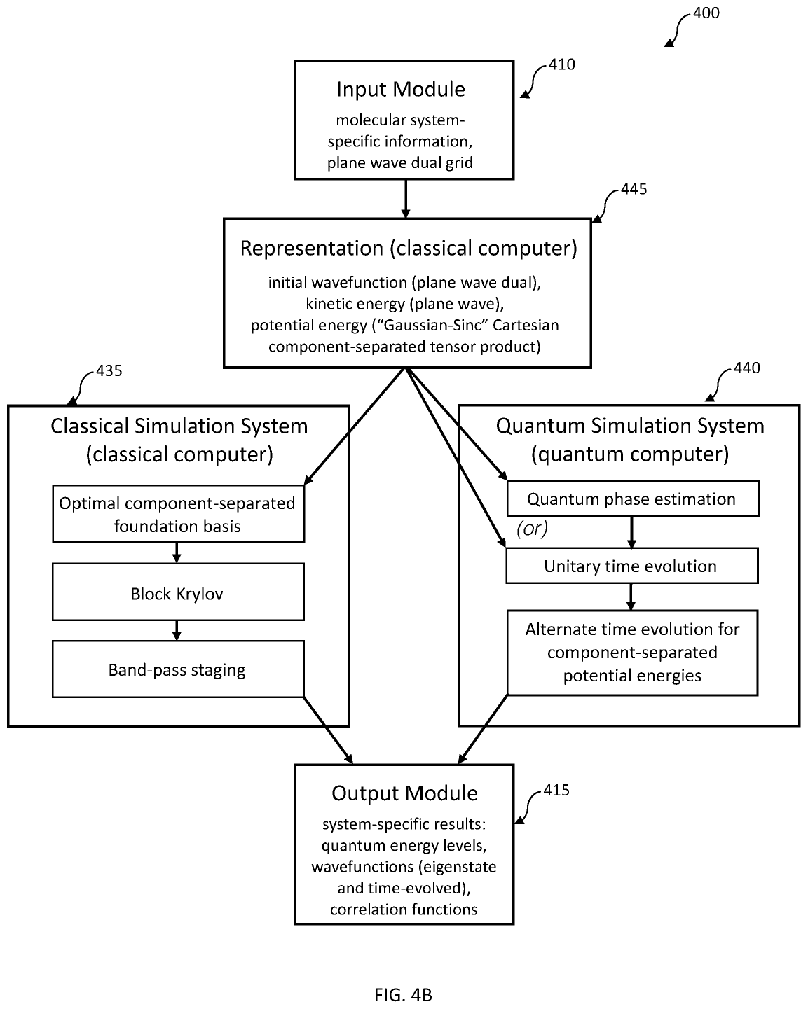

FIG. 4A and FIG. 4B depict exemplary modeling systems 400 for simulating the quantum physics of a molecular system, using either one or both of a classical computer 100 or a quantum computer 405. The exemplary quantum modeling system 400 is an example of a system implemented using classical and/or quantum computer programs on one or more classical computers 100 or quantum computing devices 405 in one or more locations, in which the systems, components, and techniques described below can be implemented.

In certain embodiments a quantum modeling system 400 can include quantum hardware configured to interface with a classical computer such as computer system 100 as illustrated in FIG. 1. In certain embodiments, the quantum model simulation is performed on a quantum computer 405. In other embodiments, the quantum model simulation is performed on a classical computer 100. In other embodiments, aspects of the simulation can be performed on the classical computer 100 and other aspects can be performed on the quantum computer 405.

The quantum modeling system 400 can include an input module 410 for inputting data describing a physical system that is to be modeled or simulated. In certain embodiments, this data can comprise data indicative of the number of electrons; the identity and spatial positions of all atomic nuclei; and the initial wavefunction. The input data can also include data pertaining to the plane-wave-dual grid-based representation 445 (coordinate grid spacing, min and max coordinate values, and number of grid points).

In most cases, this input data will suffice to generate all required elements of the first-quantized Hamiltonian matrix representation 445, characterizing the physical system that is to be modeled or simulated, although in some embodiments, such data can be provided as additional input. Elements of the first-quantized Hamiltonian may be written in the following basis representations: plane wave (i.e., Fourier, or momentum-space); plane wave dual (i.e. grid-based, Sinc, or position-space). Additionally, elements of the potential energy contributions to the Hamiltonian may be expressed in “Gaussian-Sinc” Cartesian component-separated tensor-product form.

The quantum modeling system 400 can also include an output module 415 wherein data representing one or more quantum chemistry solutions (ground and/or excited state energy levels, eigenstate and time-evolved wavefunctions, correlation functions, etc.) can be presented. The data can represent one or more simulated quantum states of a particle, or system of particles, such as a molecule or chemical reaction.

The quantum modeling system 400 can be configured to perform all operations with a classical computer only, or can be configured to perform certain operations in combination with a quantum computer 405 using quantum hardware, and/or can be configured to perform operations with a quantum computer 405 using quantum hardware. The quantum hardware may include components for performing quantum computation. For example, the quantum hardware can include a quantum control and a quantum system. It should be appreciated that the quantum control and quantum system can be embodied as any number of known quantum computing systems without departing from the scope of this disclosure.

The quantum simulation system 400 can include one or more multi-level quantum data storage 420. The multi-level quantum data storage structures can be referred to as qubits. The type of quantum computer that the quantum simulation system 400 uses can be selected from a variety of known quantum computing systems which can include one or more resonators attached to one or more superconducting qubits, e.g., Gmon or Xmon qubits. In other cases, ion traps, nuclear or electron spin, photonic devices, topological anyons, or superconducting cavities can be used. In other embodiments quantum subsystems include fluxmon qubits, silicon quantum dots or phosphorus impurity qubits. The quantum computer can include quantum circuits. The quantum computer 405 can include a control module or device 425 used to control quantum logic gates 430 associated with the quantum simulation system.

The quantum hardware can further be selected according to the type of qubits included in the quantum computer 405. For example, in some cases the control devices can include devices that control the frequencies of qubits included in the quantum computer 405, e.g., an excitation pulse generator and control lines that couple the qubits to the excitation pulse generator. The control devices can then cause the frequency of each qubit to be adjusted towards or away from a quantum gate frequency of an excitation pulse on a corresponding control driveline. The control devices can also include measurement devices such as readout resonators. Measurement results obtained via measurement devices can be provided to the classical processors for processing and analyzing.

In certain embodiments, the classical simulation system 435 can be configured to use much more efficient basis set representations than the plane wave (dual) choice used in the quantum simulation system 440. However, in certain embodiments, the classical simulation system 435 can also be used to simulate the quantum simulation system itself, by creating a modeled solution to a given first-quantized Hamiltonian as it would be solved by the quantum computer (i.e., using plane wave (dual) basis sets and Cartesian component-separated representations of the potential energies).

Quantum chemistry, which may (when nuclear motion is ignored) also be referred to herein as “electronic structure,” is the numerical simulation of quantum mechanical states of electrons in molecules. Such states can be described by an electronic wavefunction. An electronic wavefunction can be represented numerically on a computer. As a simplified example, take a one-dimensional function, f(x). To represent this function on a computer, it is necessary to first define a set of L uniformly spaced “grid points” in x, i.e. xₖ=kΔ, where Δ is the grid spacing. The function f(x) can then be represented as a vector with L components, by evaluating the function at each of the L grid points, i.e. {ƒ(x₁), ƒ(x₂), . . . , ƒ(x_{L})}.

An electronic representation of the continuous function f(x) thus requires a total of L numbers that must be stored on a computer. For a single electron, the wavefunction, denoted “ψ,” is a function of the electron's position in physical space, (x, y, z). It should be noted that the present approach does not require Slater determinants. As such, for the examples that involve Hamiltonians for which spin does not explicitly appear (e.g. no spin-orbit coupling), spin can be largely ignored. Since physical space is three dimensional, the corresponding grid points form a cubical lattice with L×L×L=L³ grid points in all. For example, in a typical application, where L=100 per dimension, a grid of 100×100×100=10⁶, one million grid points is required. By extension, to represent the wavefunction for a single electron, ψ(x, y, z), one million numbers must be stored on the computer. This is well within the capability of classical computers.

However, for multiple electrons the problem size scales up very quickly, i.e. exponentially. For the general case of N electrons, the wavefunction, ψ(x₁, y₁, z₁, x₂, y₂, z₂, . . . , x_{N}, y_{N}, z_{N}), depends on the positions of all N electrons, and all such possible combinations must be considered. To represent this wavefunction, computer storage of L^{3N} numbers is required. Even for just the simplest example of N=2 electrons, the wavefunction, ψ(x₁, y₁, z₁, x₂, y₂, z₂), requires a grid of L×L×L×L×L×L=L⁶=10¹² or one trillion points. This is at the computational limit of current technology. Of course, for more electrons, the situation becomes increasingly untenable. Since all neutral atoms but two (H and He) and all neutral molecules but one (H₂) contain more than two electrons, the ability to represent other atoms or molecules in this manner is difficult.

Furthermore, quantum chemistry requires more than just the numerical representation of ψ. To solve the quantum chemistry problem for a given molecular system, it is also necessary to represent the Hamiltonian, which is an operator comprised of the kinetic and potential energies of all particles in the system. The Hamiltonian is represented as a matrix, or large table of numerical entries. In general, the number of entries in a matrix is the square of the number in the corresponding vector. Thus, for the above grid representation, the Hamiltonian matrix, H, includes a total of (L^{3N})²=L^{6N} numerical entries. Consequently, even for just the simplest case of N=2, 10²⁴ numbers would be required to store the Hamiltonian matrix explicitly. This may be referred to herein as the “first-quantized” approach.

Various approaches can be used to mitigate the staggering numerical overhead associated with the first-quantized quantum chemistry problem as described above—which would otherwise be devastating for any realistic classical simulation. First, instead of working with the full 3N-dimensional wavefunction directly, almost all classical computing algorithms make use of “Slater determinants,” which effectively reduce things to single-particle pieces. Second, instead of working with the uniform grid representation described above (what is also referred to here as the “plane wave dual” or “Sinc” representation), much more efficient basis representations are typically used (e.g., molecular orbitals) in terms of which far fewer than L³≈10⁶ numbers are needed for a single particle. Many other complex refinements are also used in practice, as a consequence of which quantum chemistry calculations can routinely be performed for larger systems. Collectively, these may be referred to herein as “second-quantized” approaches.

On the other hand, second-quantized calculations are not always reliably accurate, especially when the number of electrons is large, or when electron correlation is substantial. Moreover, they are often restricted to computing just the single lowest-lying or “ground” quantum state, or perhaps a handful of low-lying excited states. To achieve reliable accuracy with controlled error bars, even when electron correlation is very substantial, and to compute large numbers of electronically excited states, including wavefunctions in full dimensionality, first-quantized methods must be used.

For quantum computational chemistry, both second-quantized and first-quantized methods have been considered, and are disclosed herein. The former can use “hybrid” strategies that combine both quantum and classical computers for the most computationally intensive operations. However, these are regarded as “short-term” quantum computing solutions. In contrast, first-quantized methods are envisioned for the long-term strategy because quantum computers are ideally suited to handle exponential growth of data. In particular, the number of qubits required to store an electronic wavefunction vector scales only linearly in the number of electrons N, or in the number of dimensions 3N.

More specifically, L=2ⁿ, where n is the number of qubits needed per dimension. This number is not very large; for example, n=7 already suffices to reach L≥100. To represent the full-dimensional wavefunction qi for N electrons, only 3Nn qubits are required. The total number of qubits for a first-quantized N=2 calculation would thus only be 3×2×7=42 qubits. Despite this tremendous reduction in storage, as compared to the number of bits required in a classical simulation, current quantum computer hardware is still limited to something like 50-100 qubits, and perhaps 10,000 quantum gate operations. Accordingly, first-quantized quantum computational chemistry requires improved quantum algorithms that can reduce both the number of qubits and the quantum gate operations required.

Even on the classical computing side, a viable first-quantized methodology can be applied to systems with up to N=4 explicit electrons. This “Gaussian-Sinc” methodology exploits a tensor product expansion of ψ that factors by Cartesian component, rather than by particle (as in the second-quantized Slater determinant approaches). As a result, very few terms are needed in the tensor product expansion—and in fact, many fewer grid points per dimension, L, are also needed (e.g., n=6). This Cartesian component-separated tensor-product approach constitutes a machine learning methodology that can be applied to first-quantized quantum chemistry.

It is an aspect of the disclosed embodiments to accurately represent both the many-particle wavefunction qi and the corresponding first-quantized Hamiltonian matrix, H. In this context, “solving” the quantum chemistry problem means diagonalizing H—i.e., transforming it so that only the diagonal matrix elements are non-zero. The resultant L^{3N} diagonal matrix elements represent the quantized energy levels or “eigenvalues” of the electronic states. The resultant eigenvectors represent the corresponding energy eigenstate wavefunctions. The latter can be further processed to obtain correlation functions of various kinds.

In accordance with the disclosed embodiments, solution as outlined above can be realized using the simulation system 400, embodied by the quantum simulation system 440 and the classical simulation system 435. For the quantum simulation system 440, 3Nn qubits are used to represent qi, whereas for the classical simulation system 435, the highly compact Gaussian-Sinc Cartesian component-separated tensor-product expansion is used to represent ψ.

The first-quantized electronic structure Hamiltonian operator takes the form of equation (1):

$$\hat{H} \approx {\sum }_{i = 1}^{N} \frac{{\hat{p}}_{ix}^{2}}{2 {m}_{e}} + \frac{{\hat{p}}_{iy}^{2}}{2 {m}_{e}} + \frac{{\hat{p}}_{iz}^{2}}{2 {m}_{e}} + {\sum }_{i = 1}^{N} {\hat{V}}_{ext} ( {x}_{i} , {y}_{i} , {z}_{i} ) + {\sum }_{i < j}^{N} {\hat{V}}_{ee} ( {x}_{i} , {y}_{i} , {z}_{i} , {x}_{j} , {y}_{j} , {z}_{j} ) \qquad ( 1 )$$

where mₑ is the electron mass, i labels individual electrons, and the three summations, respectively, represent kinetic energy, (one-electron) external potential energy (due to nuclear attractions), and (two-electron) pair-repulsion potential energy. The kinetic energy separates by both particle and Cartesian component. Hence, each term can be stored using a single-coordinate matrix of L² entries, in the plane-wave-dual representation. In the Fourier or plane-wave representation, this matrix becomes diagonal, and so only the L diagonal entries need be stored explicitly. This representation of the kinetic energy is used in the disclosed embodiments. Efficient Fourier transform algorithms can be used to transform between the plane-wave and plane-wave-dual representations, on both classical and quantum computers.

The external and pair-repulsion potential energy matrix representations are diagonal in the plane-wave-dual representation. These matrices thus require storage of L³ and L⁶ diagonal entries, respectively. However, in the disclosed embodiments, for both classical 435 and quantum 440 simulation systems, the Gaussian-Sinc approach is followed, giving rise to a highly compact Cartesian component-separated tensor-product form, whose few constituents require at most L² storage each.

In accordance with the disclosed embodiments, “direct” diagonalization of the explicit matrix representation is replaced with a series of matrix-vector products for which the computational cost is reduced by many orders of magnitude. This is accomplished by using computer code to simulate the action of a matrix on a (wavefunction) vector, in a way that: (i) requires storing far fewer numbers than would be required for the matrix itself; (ii) applies far fewer (logic or quantum) gate operations than would be required in a direct dense matrix-vector product.

In some embodiments of the classical simulation system 435, the matrix that multiplies the vector is H itself. Repeated applications of H on even a random vector eventually results in the ground state wavefunction. However, on a quantum computer, matrix-vector products generally require the matrix to be unitary, whereas in reality, the matrix H representing Eq. (1) is not unitary but Hermitian. Therefore, in the embodiments disclosed herein pertaining to the quantum simulation system 440, H is replaced by U=exp[−iHt], where t is a parameter, which can represent time (if Planck's constant is set equal to one, as is presumed here). Note that even a single application of exp[−iHt] to an initial wavefunction ψ(0) results in the time-evolved wavefunction ψ(t). This is therefore a solution of the time-dependent Schrödinger equation—another important application of the embodiments disclosed herein.

In some embodiments of the quantum simulation system 400, the goal is to solve the time-independent Schrödinger equation—i.e., to diagonalize the matrix H or U. The embodiments disclosed herein are directed to a long-term, or true bona fide quantum computing solution. In this context, the only general such “eigensolve” algorithm available is the quantum phase estimation (QPE) algorithm. The basic QPE algorithm is designed to compute only the ground state energy, although more recent implementations have been designed for excited states. For reference, basic features of the QPE algorithm encompass: 1) multiple applications of matrix-vector products with U=exp[−iHt], as described above; 2) application of the quantum Fourier transform (QFT) routine; and 3) initial wavefunction ψ(0) designed to be “fairly close” to the true ground state wavefunction.

The embodiments disclosed herein provide methods and systems for computing matrix-vector products with: (i) H, for the classical simulation system 435; and (ii) U=exp[−iHt], for the quantum simulation system 440. This is for H the first-quantized Hamiltonian, represented in the plane wave (dual) basis, using a Cartesian component-separated tensor-product expansion for the potential energies (and in the classical simulation case, also for the wavefunction).

In one embodiment, methods and systems to compute first-quantized electronic structure energy levels and wavefunctions on a classical computer are disclosed and illustrated in FIGS. 4A, 4B, 5, and 6.

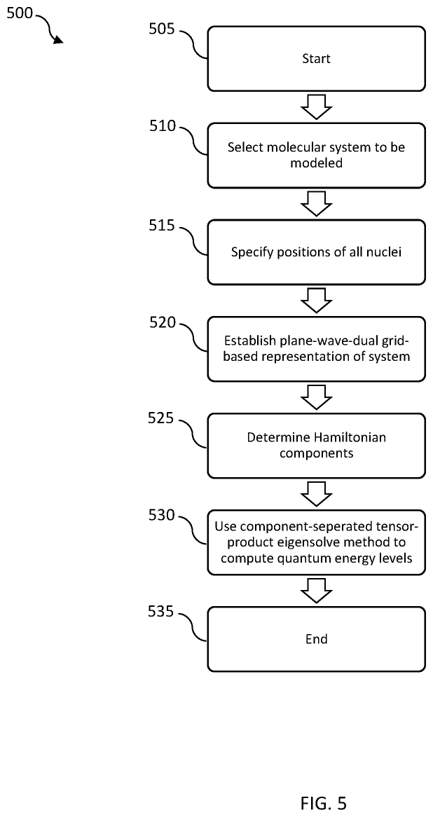

FIG. 5 illustrates steps associated with a method 500 for simulating quantum computational chemistry on a classical computer. It should be appreciated that method 500 can be realized using the systems illustrated in FIGS. 1-4. The method begins at 505.

The first step is to select a molecular system to be modeled as illustrated at step 510. Positions for all nuclei can be specified as illustrated at 515. Next at step 520, a plane-wave-dual grid-based representation of the system can be established. This can include coordinate grid spacing, min and max coordinate values, and the number of grid points.

The next step is to determine Hamiltonian components, as shown at step 525, based on the grid created in step 520. These can include the kinetic energy (plane-wave representation) and potential energy (Cartesian component-separated tensor-product form in plane-wave-dual representation). Finally, at step 530, the component-separated tensor-product eigensolve methodology can be used to compute quantum energy levels (and in certain embodiments, wavefunctions and correlation functions). The method ends at 535.

The disclosed methods and systems can be applied to atomic and molecular applications with up to at least four explicit electrons (N=4). As noted above, storing that amount of data using explicit vectors on a classical computer would be impracticable. However, the disclosed embodiments do not store every one of the L^{3N} wavefunction vector entries explicitly.

Instead, a compactified “Gaussian-Sinc” Cartesian component-separated tensor product representation (as further detailed herein) can be used, whose storage scales no worse than 3L^{N}. More specifically, the first-quantized wavefunction, ψ(x₁, y₁, z₁, x₂, y₂, z₂, . . . , x_{N}, y_{N}, z_{N}) is replaced with the form:

$$ψ \approx {\sum }_{λ = 1}^{Γ} {X}^{λ} ( {x}_{1} , {x}_{2} , … {x}_{N} ) {Y}^{λ} ( {y}_{1} , {y}_{2} , … {y}_{N} ) {Z}^{λ} ( {z}_{1} , {z}_{2} , … {z}_{N} ) \qquad ( 2 )$$

where Γ is the number of terms in the expansion (in practice, Γ<100).

A similar component-separated tensor-product representation can be used for the potential energy contributions in Eq. (1). In principle, this is rather difficult, owing to the Coulombic nature of the interactions. Indeed, Coulombic singularities are also the primary reason why as many as L≈100 grid points per dimension are typically needed, in conventional implementations, to achieve chemical accuracy (i.e., around 1.5 mHartree). Nevertheless, the Gaussian-Sinc approach provides an even more compact tensor-product representation for the potential energies than for iv, and provides a substantial reduction in the value of L. One important aspect is to avoid actually evaluating the potential function itself at specific grid points, but to rely instead on a specific inverse Laplace transform. This is described below for the more challenging case of Vₑₑ, although the Vₑₓₜ case is similar. Note that this approach is not restricted to just Coulombic potentials, and can be realized using the systems and methods disclosed herein.

The Coulombic two-electron pair repulsion potential energy operator can be expressed as a function of the six Cartesian coordinates as follows:

Vₑₑ(x₁,y₁,z₁,x₂,y₂,z₂)=1/\sqrt{(x₂−x₁)²+(y₂−y₁)²+(z₂−z₁)²} (3)

Alternatively, Vₑₑ(s)=1/s^{1/2}, where s=(x₂−x₁)²+(y₂−y₁)²+(z₂−z₁)². Applying the inverse Laplace transform yields.

$${V}_{ee} ( s ) = \frac{2}{\sqrt{π}} {\int }_{0}^{∞} \frac{1}{2 \sqrt{t}} {e}^{- st} dt = \frac{2}{\sqrt{π}} {\int }_{0}^{∞} {e}^{- s {β}^{2}} d β \qquad ( 4 )$$

The exponential factor in equation (4) above therefore becomes:

e^{-sβ}^{²}=e^{-β}^{²}^{(x}^{₁}^{-x}^{₂}⁾^{²}e^{-β}^{²}^{(y}^{₁}^{-y}^{₂}⁾^{²}e^{-β}^{²}^{(z}^{₁}^{-z}^{₂}⁾^{²} (5)

which is a product of Cartesian component-separated factors. Substituting equation (5) into equation (4), one obtains

$${\hat{V}}_{ee} ∝ {\int }_{0}^{∞} {\hat{γ}}_{x} ( β ) {\hat{γ}}_{y} ( β ) {\hat{γ}}_{z} ( β ) d {β}_{,}$$

where the individual factors involve a single Cartesian component only, x, y, or z. This expression becomes a tensor-product sum when the β integral is evaluated by quadrature over a finite and discrete set of quadrature points, β_{λ}, where λ={1, 2, . . . , Γₑₑ}. The integral is then effectively replaced with a tensor product sum of the form shown in equation (6):

$${\hat{V}}_{ee} = {\sum }_{λ = 1}^{{Γ}_{ee}} {\hat{γ}}_{x}^{λ} {\hat{γ}}_{y}^{λ} {\hat{γ}}_{z}^{λ} \qquad ( 6 )$$

When the Cartesian component-separated tensor-product form above is represented in any component-separated basis (not even necessarily a particle-separated basis), a tensor-product sum emerges. In some embodiments, (e.g., when benchmarking the quantum simulation system), a plane-wave or plane-wave-dual basis can be presumed. Whereas potential energy operators are generally taken to be diagonal in the latter representation (by evaluating the potential function directly at the grid points), this is in fact only an approximation. Greater accuracy can therefore be obtained by evaluating the plane-wave-dual matrix elements exactly—leading to component-wise γ_{d}_{^{λ}} matrices that are not diagonal, but which treat the Coulombic singularity more effectively. Various embodiments may employ either the diagonal or non-diagonal forms as described above; others may use more general basis representations, including those that are not particle-separated.

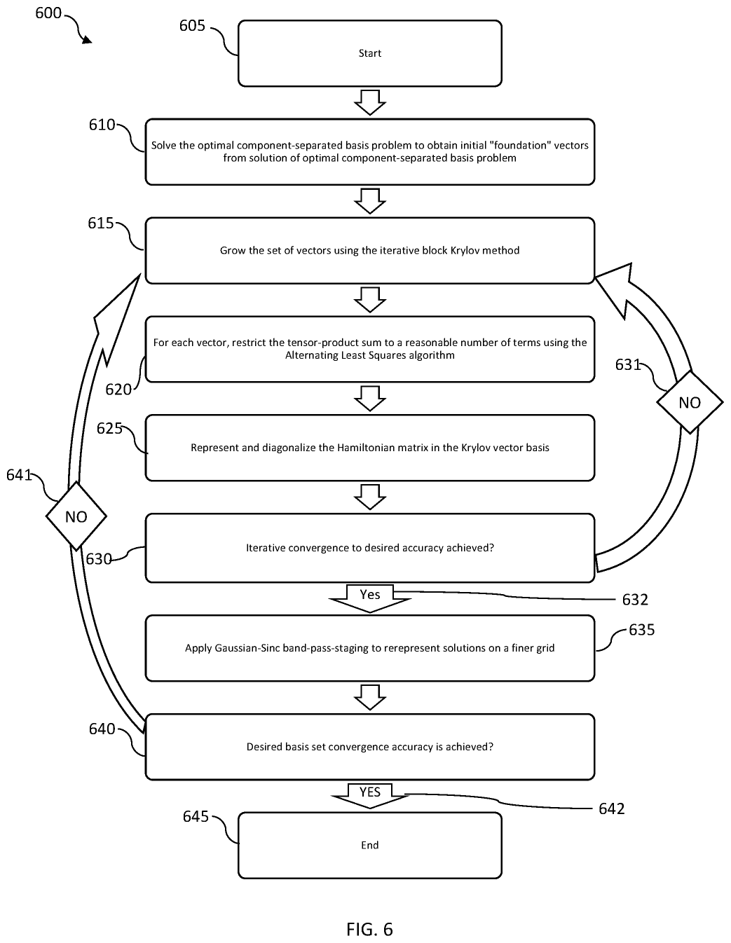

Using the Cartesian component-separated tensor-product forms for both the first-quantized H and ψ as described above (note that the kinetic energy is already component-separated), the procedure for diagonalizing the matrix H is described in FIG. 6.

FIG. 6 depicts steps associated with a method 600 for the Cartesian component-separated tensor-product eigensolve methodology. The method 600 begins at step 605.

The first step, illustrated as step 610, is to solve the optimal component-separated basis problem, in order to obtain initial “foundation” vectors. Each foundation vector is a single Cartesian component-separated product. Next, the set of vectors is grown using the iterative block Krylov method as shown at step 615, which preserves the Cartesian component-separated tensor-product form. Next, for each new Krylov vector that is added to the set, the number of terms in the tensor-product sum is restricted to a reasonable value, using the Alternating Least Squares algorithm as shown at step 620. Next at step 625, every few iterations, a compact Hamiltonian matrix h is explicitly generated and diagonalized in the current Krylov vector basis, to obtain ground and excited state energy levels and wavefunctions.

Block 630 illustrates new iterations applied until iterative convergence to a desired accuracy is achieved. If convergence to the desired accuracy is not achieved as shown by block 631, the method returns to step 615. If convergence to the desired accuracy was achieved as shown by block 632, Gaussian-Sinc band-pass staging can be applied to represent the solutions on a finer grid as shown at step 635. At step 640 a decision is made to determine if the desired basis set convergence accuracy has been achieved. If it has not as illustrated at block 641, the whole process above is repeated, until basis set convergence to a desired accuracy is achieved as illustrated by yes block 642. The method ends at step 645.

More specifically, the overall eigensolve procedure for diagonalizing the matrix H as described above, can be accomplished as follows. First, at step 610, the optimal component-separated approximation of the form H≈Hₓ+H_{y}+H_{z} is determined, by minimizing the Frobenius norm of the matrix (H−Hₓ−H_{y}−H_{z}). Then, each reduced-dimensional single-Cartesian-component problem is solved, by diagonalizing Hₓ, H_{y}, and H_{z}. The solutions are the single-component eigenstate wavefunction vectors, ϕₓ_{^{j}}(x₁, . . . x_{N}), ϕ_{y}_{^{j}}(y₁, . . . y_{N}), and ϕ_{z}_{^{k}}(z₁, . . . z_{N}). Next, the optimal component-separated basis on the full problem space is obtained from the direct products of the single-component eigenstate wavefunction vectors above. Those direct-product functions that are energetically lowest-lying are taken as the “foundation” vectors, or initial wavefunctions. A total of B such foundation vectors is taken in all.

An iterative block Krylov procedure is then employed as shown at step 615. In each iteration, each of the most recent set of B Krylov vectors (starting with the foundation) is multiplied by H, in order to create a new set of B Krylov vectors. This operation preserves the Cartesian component-separated tensor-product form of the Krylov vectors, as indicated in Eq. (2). However, each iteration increases the “rank” Γ, or total number of terms in the tensor-product sum. To prevent the calculation from becoming unwieldy, after each iteration, the Alternating Least Squares algorithm is applied as needed, to ensure that r for each vector remains smaller than some specified maximum value.

After every few iterations, the matrix H is projected onto the set of all Krylov vectors defined up to that point. The result is a much smaller matrix, h, with eigenvalues close to those of H itself, at the bottom of the spectrum. The matrix h is then directly diagonalized, in order to compute eigenvalues (energy levels) and eigenvectors (eigenstate wavefunctions).

Because spin variables are not explicitly included in the calculation, and because Slater determinants are not used to enforce overall (i.e. including spin) permutation antisymmetry, some of the computed eigenvalues will not be physically relevant. In order to restrict the calculation to the physically relevant states (and more generally, in order to compute proper statistical weight factors), permutation symmetry-adaptation of h is applied, prior to diagonalization, as shown at step 625. In some embodiments, symmetry-adaptation is applied to the Krylov vectors, and/or to H itself as shown at step 625.

After each eigenvalue calculation, results for the states of interest are compared with those of previous iterations, to determine the current level of iterative convergence accuracy at step 630. The entire process is repeated until iterative convergence errors are reduced below a desired threshold for all states of interest.

Once iterative convergence is achieved as described above, the accuracy of the calculation may still be limited by the size of the representational basis. More accurate results can be obtained by using smaller grid spacings Δ, as shown at step 635, smaller minimum, and/or larger maximum coordinate limits—all of which result in larger L. In order to ensure basis set convergence, the process can be performed as described above for successively larger grids, until the desired threshold accuracy is reached as shown at step 640.

An efficient way to implement the above basis set convergence method is through the use of band-pass staging as shown at step 635. This refers to using the iteratively converged output of one process as the input or foundation basis for a subsequent larger-L process. Even though the two grids are generally incommensurate, the plane-wave-dual basis allows for an “exact translation” from the smaller grid to the larger grid (where the exactness is evident on consideration of the corresponding plane-wave-basis sets, the smaller of which is completely contained within the larger). In some embodiments, band-pass staging may encompass use of the most recent eigenvectors as a new foundation, without changing grids.

In an exemplary embodiment, the method disclosed above can be used to simulate the results of a quantum computational chemistry calculation—i.e., to simulate the operation of the quantum simulation system itself—on a classical computer as illustrated in FIGS. 1-4.

At present, it is not possible to directly translate the classical simulation algorithm outlined above, directly over to a quantum computer. It should be noted however, that the representation outlined in the method 600 above—in particular, the grid-derived inverse-Laplace-based, Cartesian component-separated form of Vₑₑ and Vₑₓₜ—is suitable for use on a quantum computer, such as quantum computer 405, and can lead to a reduction in the number of qubits (e.g., from n=7 to n=6).

In certain embodiments, the methods above can be used to simulate the performance and requirements of a quantum computational chemistry solution, using a classical computer. Because current quantum computers are very limited in their performance, and also show variability in their computed results to the same benchmark problems—there is a great short-term need to predict both the quantum computational requirements and the correct results for challenging benchmark applications.

To that end, the disclosed methods offers a number of advantages. First, the above method uses a plane-wave-dual grid-based representation—that is to say, it uses the same underlying grid-based representation that may be used in long-term quantum computational chemistry.

In addition, methods and systems disclosed herein can be considered a first-quantized approach. Computing the electronic wavefunction in full-dimensionality as described herein is a first-quantized approach, which is again what will be used in long-term quantum computational chemistry, but very unlike the vast majority of standard quantum chemistry methods, which are “second-quantized.”

Furthermore, the disclosed method does not require Slater determinants, and can therefore encompass more complex permutation symmetry patterns than just overall antisymmetry. This means that the disclosed method can also provide solutions for the combined electron-nuclear problem. It should be appreciated that the disclosed systems and methods can comprise long-term quantum computational chemistry solutions related not just to electrons, but can also include atomic nuclei. This is impossible to simulate using standard quantum chemistry codes, but easily handled by the disclosed methods.

As such the disclosed method and system represent a means for accomplishing accurate simulations of quantum computational chemistry (i.e., simulations of quantum chemistry run on a quantum computer) on a classical computer. The methods involves first, using the grid-based representation as would be used on a quantum computer, and second, using the disclosed algorithm to compute the resultant energy eigenvalues (both ground state and excited). This provides detailed information not only about accurate numerical results that should be expected on a quantum computer, but also important performance information such as the dependence of the computed accuracy on the grid size, which for a quantum computer, can be translated into the required number of qubits. Moreover, by combining these results with some of the disclosed methods it is possible to estimate the required number of quantum gates, as well.

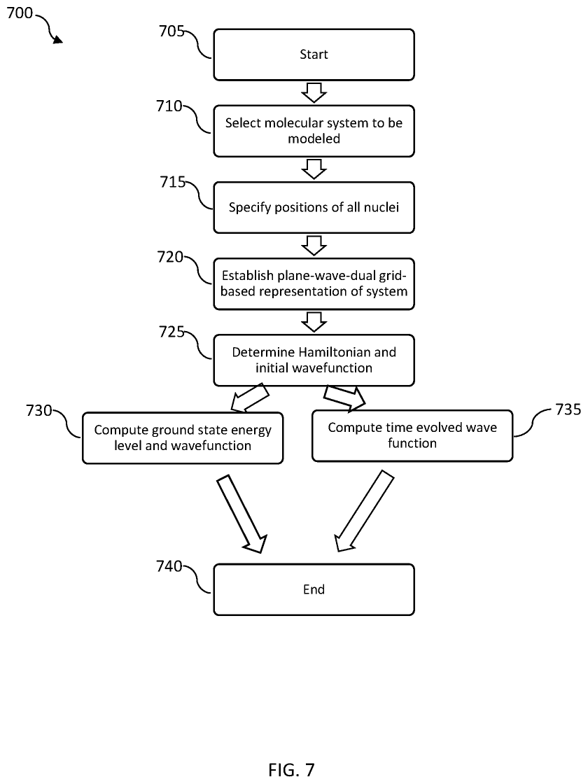

Insofar as running quantum chemistry calculations on a quantum computer as disclosed herein, the first-quantized grid based representation described above is extremely well-suited to this task, but the actual algorithm described above, designed for use on a classical computer, is not. However, in another embodiment, true quantum computational chemistry (i.e., on a quantum computer 405) can also be realized with the methods and systems disclosed herein. A method 700 for quantum computational chemistry is outlined in FIG. 7. The method begins at 705.

The first step, illustrated at 710, is to select a molecular system to be modeled. Positions for all nuclei can be specified as illustrated at step 715. Next, at step 720 a plane-wave-dual grid-based representation of the system can be established. This can include coordinate grid spacing, min and max coordinate values, and the number of grid points.

The next step 725 is to determine the Hamiltonian and other components based on the grid created in the previous step 720. These can include the kinetic energy (plane-wave representation) potential energy (Cartesian component-separated tensor-product form in plane-wave-dual representation), and initial wavefunction |ψ(0) [symbol] (plane-wave-dual representation).

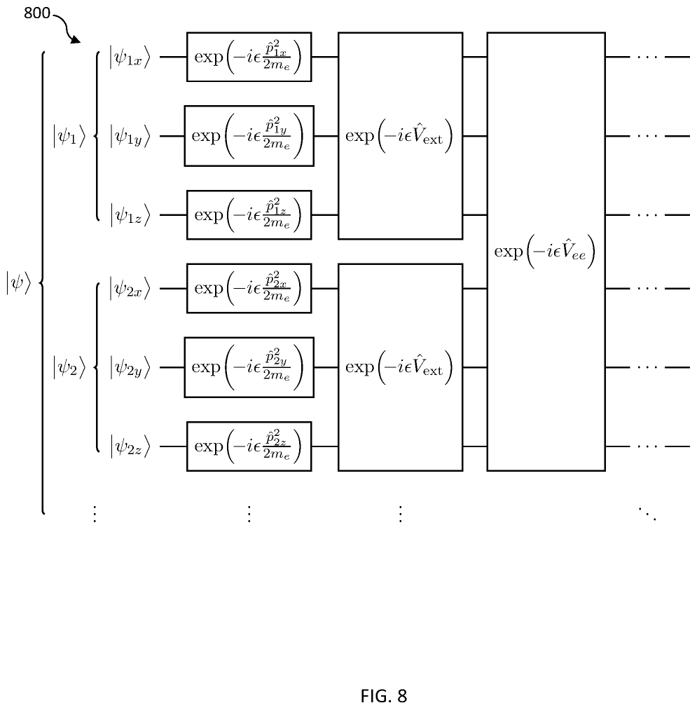

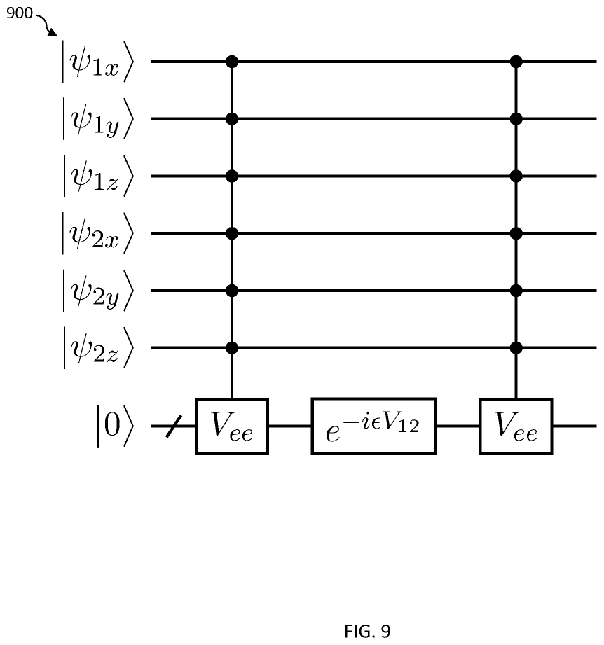

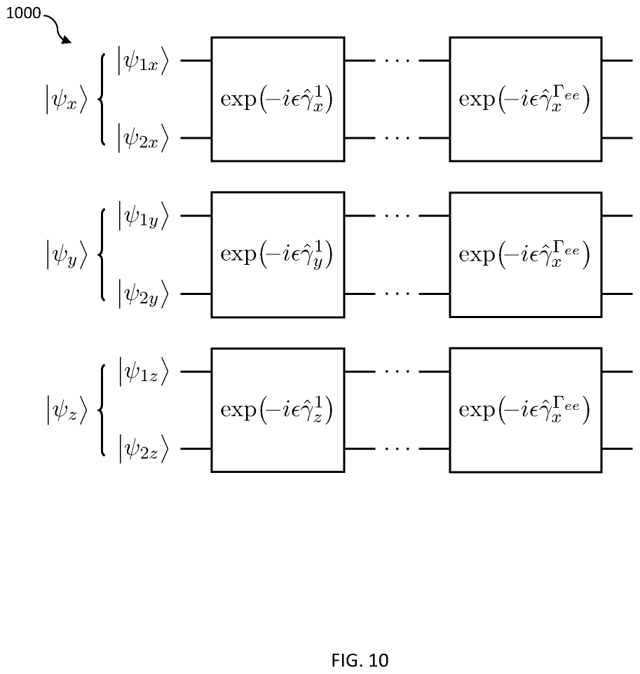

To compute the ground state energy level and wavefunction at step 730, the QPE algorithm can be applied. This requires computing the time evolved wavefunction |ψ(t) [symbol] =Û(t)|ψ(0) [symbol] . In some embodiments, finding the time-evolved wavefunction is itself the desired solution as illustrated at step 735. In either context, this is achieved by applying a sequence of Û(ε)|ψ [symbol] operations with a small time step ε, and using the Trotter approximation as depicted in the quantum circuit 800 illustrated in FIG. 8. For the potential energy contributions, the alternate quantum circuit 1000 implementation of FIG. 10 can be used, as opposed to the standard circuit 900 illustrated in FIG. 9. The method ends at step 740.

More specifically, all relevant operations addressed herein for implementation on a quantum computer 405 require the action of the matrix U(t)=exp[−iHt] on a wavefunction vector. This is implemented via repeated applications of U(c), where c is a time step selected to be sufficiently small so that individual contributions from Eq. (1) can be applied separately. Thus, we obtain the following “Trotter approximation”:

$$\hat{U} ( ϵ ) \approx … exp [ - i ϵ {\hat{V}}_{ee} ( {x}_{1} , {y}_{1} , {z}_{1} , {x}_{2} , {y}_{2} , {z}_{2} ) ] … exp [ - i ϵ {\hat{V}}_{ext} ( {x}_{1} , {y}_{1} , {z}_{1} ) ] \times … exp [ - iϵ \frac{{\hat{p}}_{1 z}^{2}}{2 {m}_{e}} ] exp [ - iϵ \frac{{\hat{p}}_{1 y}^{2}}{2 {m}_{e}} ] exp [ - iϵ \frac{{\hat{p}}_{1 x}^{2}}{2 {m}_{e}} ] \qquad ( 7 )$$

The matrix-vector product for each factor in Eq. (7) above can be implemented separately.

As a technical note, the Trotter procedure of splitting the kinetic energy into two separate factors, one placed at the start and one at the end of the product chain, is ignored in our notation: (i) for simplicity; (ii) because it makes little difference in practice, when multiple U(e) factors are applied in succession.

A broad-brush-stroke quantum circuit 800 implementation of U(ε)ψ is presented in FIG. 8. As discussed, there is one group of n representational qubits associated with each of the 3N dimensions or coordinates—and correspondingly, with each ψ_{id} part of ψ (where i refers to a specific electron, and d to a specific Cartesian component, x, y, or z). Since for each such coordinate, a fixed number of qubits is needed (i.e. n=6 for the present approach), and since there is no reason to consider subdividing below the level of a single coordinate, in FIG. 8 and all of the quantum circuit diagrams presented here, we treat connections involving a single ψ_{id} as if they were single-qubit wires, rather than bundles. On the other hand, the usual “slash” notation will be used for ancilla qubit bundles—e.g., as are employed to store function output values. To achieve chemical accuracy, each such ancilla qubit bundle will typically require perhaps 15-20 qubits. Note that for the overview quantum circuit 800 diagram of FIG. 8, the associated ancilla bits, needed to carry out the individual operations in practice, are not shown in the figure.

Since potential energies are (traditionally) diagonal in the plane-wave-dual representation, their contributions to the time evolution can be implemented using the standard function evaluation approach. The corresponding standard quantum circuit 900 for implementing exp(−iε\hat{V}ₑₑ)|ψ₁₂ [symbol] is given in FIG. 9. Here, a bundle of ancilla qubits are needed to represent the value of the function, V₁₂=Vₑₑ(x₁,y₁,z₁,x₂,y₂,z₂), which is then used to effect a phase shift. The difference in notation, i.e. e^{-iεV12} for the phase shift gate itself, and exp(−iε\hat{V}ₑₑ) for the corresponding quantum operator, should be noted.

In practice, the function evaluation gate marked Vₑₑ in FIG. 9 is itself quite complicated to implement, as it involves six explicit coordinates, and therefore six wavefunction wires, or groups of n qubits each. In terms of the Cartesian coordinates used, this two-electron pair repulsion potential is highly correlated, and also involves Coulombic singularities. The latter feature (albeit mostly due to Vₑₓₜ) further requires a high density of plane-wave-dual grid points to model accurately, and therefore a relatively large number of qubits per coordinate group, n. All of this renders the exp(−iε\hat{V}ₑₑ)|ψ₁₂ [symbol] operation the “quantum computational bottleneck” of the standard quantum computational chemistry approach, requiring a great many quantum gates to implement.

A similar quantum circuit to that of FIG. 9 may be implemented for exp(−iε\hat{V}ₑₓₜ)ψ₁ [symbol] except that only three wavefunction wires are required, instead of six. This is still a larger number than desired. Note that for the kinetic energy, since this contribution is separable by both particle and Cartesian component, only a single wavefunction wire is needed to implement each exp(−iε\hat{p}_{id}²/2mₑ)|ψ_{id} [symbol] operation. On the other hand, the quantum circuit 900 of FIG. 9 must be modified via the action of the quantum Fourier transform on the wavefunction wire at the start of the circuit, and the corresponding inverse quantum Fourier transform at the end of the circuit. This extra step is necessary in order to transform from the plane-wave-dual to the plane-wave representation, in terms of which the matrix representation for exp(−iε\hat{p}_{id}²/2mₑ) becomes diagonal.

All quantum computing algorithms can be decomposed into quantum circuits comprised of quantum gates that manipulate qubits, one or two at a time. It is vitally important to try to keep the total number of such quantum gate operations as small as possible, because all present-day physical implementations of quantum computing hardware are limited in terms of the total number of qubits and gate operations that can be successfully treated. As a consequence, whereas in theory, a quantum circuit can be devised to simulate any desired computation, in practice, present-day and near-future quantum computers are limited in terms of what they can actually do.

In light of the complexity of the Vₑₑ function evaluation gate in FIG. 9, an alternate, simplified algorithm is desired, involving fewer quantum wires and quantum gates. Such an algorithm is disclosed here, in the quantum circuit 1000 diagram of FIG. 10.

In particular, the Cartesian component-separated form of the potential energies, as given explicitly for Vₑₑ in Eq. (6), is adopted, as tensor products are straightforward and efficient to implement in a quantum circuit. Importantly, this reduces the calculation to much simpler, Cartesian component-separated contributions of the form exp(−iε\hat{γ}_{d}^{λ})|ψ_{1d2d} [symbol] , involving just two wavefunction wires each (e.g., for coordinates x₁ and x₂). In comparison with the standard approach, the reduction from six down to two wavefunction wires, or from 3×2×7=42 qubits down to just 1×2×6=12 qubits, can result in a substantial reduction in the number of quantum gates required. Note that quadrature schemes with as few as Γₑₑ=22 have been found to provide accuracies near to machine precision, with substantially smaller Γₑₑ values needed for chemical accuracy.

As discussed herein, in some embodiments, the plane-wave-dual representation of exp(−iε\hat{γ}_{d}^{λ}) is a diagonal (quadrature) approximation. In these embodiments, a two-wavefunction-wire quantum circuit (e.g. quantum circuit 900 of FIG. 9, or other such quantum circuits) may be used to implement exp(−iε\hat{γ}_{d}^{λ})|ψ_{1d2d} [symbol] . In these embodiments, in addition to the reduced number of wavefunction wires, the well-behaved form of the Gaussian function in equation (5) leads to much simpler function evaluation quantum circuits than for the poorly behaved Coulombic function evaluation, Vₑₑ in 900 of FIG. 9. Even so, in some of these embodiments, improved performance may be realized by taking some care to avoid the locations of Coulombic singularities— e.g. using staggered grids and the like.

In other embodiments, the exact plane-wave-dual representation is used, in terms of which exp(−iε\hat{γ}_{d}^{λ}) is not diagonal. As a consequence, the standard quantum circuit of FIG. 9 is not applicable. Instead, an alternate approach is disclosed, based on the fact that in the plane-wave-dual representation, the non-diagonal contributions to \hat{γ}_{d}^{λ} may be effectively rewritten to be of the form (\hat{p}₁\hat{p}₂\hat{D}+\hat{D}\hat{p}₁\hat{p}₂)/2, where D is diagonal (note that d subscripts and A superscripts have been dropped for clarity). Thus, in the ε→0 limit,

exp(−iε\hat{γ})≈exp(−iε\hat{p}₁\hat{p}₂\hat{D}/2)exp(−iε\hat{D}\hat{p}₁\hat{p}₂/2) (8)

The two factors in equation (8) are no longer unitary. Moreover, for each of these factors, the exponent takes the form of a non-commutative operator product, rather than a tensor product. For such cases, a quantum circuit implementation is disclosed, that is both unitary and correct to first order in ε. Effectively, this approach enables the three factors in the exponent to be applied separately. Thus, the two momentum factors are implemented using single-wavefunction-wire circuits with quantum Fourier transforms, and D is implemented using a two-wavefunction-wire function evaluation circuit.

Based on the foregoing, it can be appreciated that a number of embodiments, preferred and alternative, are disclosed herein. For example, in an embodiment, a method for simulating performance of quantum computational chemistry, comprises representing wavefunctions using a Cartesian component-separated tensor-product, representing the Hamiltonian using a Cartesian component-separated tensor-product, and computing resultant energy eigenvalues and eigenstate wavefunctions of the Hamiltonian for one or more quantum states, with a classical computer.

In an embodiment, a method for simulating performance of quantum computational chemistry, comprises representing wavefunctions using a Cartesian component-separated tensor-product, representing the Hamiltonian using a Cartesian component-separated tensor-product, and computing resultant energy eigenvalues and eigenstate wavefunctions of the Hamiltonian for one or more quantum states, with a classical computer.

In certain embodiments of the method for simulating performance of quantum computational chemistry, representing wavefunctions using a Cartesian component-separated tensor-product further comprises representing wavefunctions using a Cartesian component-separated tensor-product on a plane-wave-dual grid. In certain embodiments of the method for simulating performance of quantum computational chemistry, representing the Hamiltonian using a Cartesian component-separated tensor-product further comprises representing the Hamiltonian using a Cartesian component-separated tensor-product on a plane-wave-dual grid.

In certain embodiments of the method for simulating performance of quantum computational chemistry, determining the number of qubits required for a commensurate calculation with a quantum computer and determining the number of quantum gates required for a commensurate calculation with a quantum computer.

In certain embodiments, the method for simulating performance of quantum computational chemistry comprises using the resultant energy eigenvalues to predict an expected output from a commensurate calculation with a quantum computer, using the resultant eigenstate wavefunctions to predict an expected output from a commensurate calculation with a quantum computer, and using correlation functions obtained from the eigenstate wavefunctions, to predict an expected output from a commensurate calculation with a quantum computer.

In certain embodiments of the method for simulating performance of quantum computational chemistry, computing resultant energy eigenvalues and eigenstate wavefunctions of the Hamiltonian for one or more quantum states, with a classical computer, further comprises establishing optimal component-separated basis sets. In certain embodiments of the method for simulating performance of quantum computational chemistry, computing resultant energy eigenvalues and eigenstate wavefunctions of the Hamiltonian for one or more quantum states, with a classical computer, further comprises determining tensor-product Hamiltonian-wavefunction matrix-vector products. In certain embodiments of the method for simulating performance of quantum computational chemistry, computing resultant energy eigenvalues and eigenstate wavefunctions of the Hamiltonian for one or more quantum states, with a classical computer, further comprises applying (block) Krylov iteration to generate new Krylov vectors. In certain embodiments of the method for simulating performance of quantum computational chemistry, computing resultant energy eigenvalues and eigenstate wavefunctions of the Hamiltonian for one or more quantum states, with a classical computer, further comprises projecting the Hamiltonian onto the Krylov vectors. In certain embodiments of the method for simulating performance of quantum computational chemistry, computing resultant energy eigenvalues and eigenstate wavefunctions of the Hamiltonian for one or more quantum states, with a classical computer, further comprises band-pass staging.

In certain embodiments of the method for simulating performance of quantum computational chemistry, the wavefunctions comprise a Cartesian component-separated tensor product of the form

$$ψ \approx {\sum }_{λ = 1}^{Γ} {X}^{λ} ( {x}_{1} , {x}_{2} , … {x}_{N} ) {Y}^{λ} ( {y}_{1} , {y}_{2} , … {y}_{N} ) {Z}^{λ} ( {z}_{1} , {z}_{2} , … {z}_{N} ) .$$

In certain embodiments of the method for simulating performance of quantum computational chemistry, the one-particle and two-particle potential energy contributions to the Hamiltonian comprise Cartesian component-separated tensor products of the form

$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$

respectively.

In another embodiment, a method for performing first-quantized quantum computational chemistry comprises establishing the representation of a physical system, representing the initial wavefunction |ψ(0) [symbol] , representing the Hamiltonian using a Cartesian component-separated tensor-product, and computing the time evolved wavefunction |ψ(t) [symbol] =Û(t)|ψ(0) [symbol] .

In an embodiment of the method for performing first-quantized quantum computational chemistry, computing the time evolved wavefunction |ψ(t) [symbol] =Û(t)|ψ(0) [symbol] further comprises computing resultant energy eigenvalues and eigenstate wavefunctions of the Hamiltonian for one or more quantum states, with a quantum computer.

In an embodiment of the method for performing first-quantized quantum computational chemistry, the representation of the physical system is a plane-wave-dual grid-based representation comprising coordinate grid spacing, minimum and maximum coordinate values, and a number of grid points. In an embodiment of the method for performing first-quantized quantum computational chemistry, the kinetic energy is represented in a plane-wave basis representation, the potential energy is represented in component-separated tensor-product form in a plane-wave-dual grid-based representation, and the initial wavefunction |ψ(0) [symbol] is represented in a plane-wave-dual grid-based representation.

In an embodiment of the method for performing first-quantized quantum computational chemistry, the one-particle and two-particle potential energy contributions to the Hamiltonian comprise Cartesian component-separated tensor products of the form

$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$

respectively.

In an embodiment of the method for performing first-quantized quantum computational chemistry, applying the Quantum Phase Estimation algorithm provides a ground state energy level and eigenstate wavefunction. In an embodiment of the method for performing first-quantized quantum computational chemistry, applying the Quantum Phase Estimation algorithm provides excited state energy levels and eigenstate wavefunctions.

In an embodiment of the method for performing first-quantized quantum computational chemistry, computing the time evolved wavefunction |ψ(t) [symbol] =Û(t)|ψ(0) [symbol] further comprises applying a sequence of Û(ε)|ψ [symbol] operations with a small time step ε, using the Trotter approximation. In certain embodiments of the method for performing first-quantized quantum computational chemistry, the one-particle and two-particle potential energy contributions to the Trotter approximation, exp(−iε\hat{V}ₑₓₜ)|ψ₁ [symbol] and exp(−iε\hat{V}ₑₑ)|ψ₁₂ [symbol] , respectively, are implemented using a Cartesian component-separated tensor-product quantum circuit.

In another embodiment, an apparatus comprises quantum hardware, the quantum hardware further comprising a quantum system comprising one or more qubits, and one or more control devices configured to operate the quantum system wherein the apparatus is configured to perform operations comprising: establishing the representation of a physical system, representing the initial wavefunction |ψ(0) [symbol] , representing the Hamiltonian using a Cartesian component-separated tensor-product, and computing the time evolved wavefunction |ψ(t) [symbol] =Û(t)|ψ(0) [symbol] .

It should be appreciated that variations of the above-disclosed and other features and functions, or alternatives thereof, may be desirably combined into many other different systems or applications. It should be understood that various presently unforeseen or unanticipated alternatives, modifications, variations or improvements therein may be subsequently made by those skilled in the art which are also intended to be encompassed by the following claims.

What is claimed is:

1. A method for simulating performance of quantum computational chemistry, comprising:
representing wavefunctions using a Cartesian component-separated tensor-product;
representing the Hamiltonian using a Cartesian component-separated tensor-product; and
computing resultant energy eigenvalues and eigenstate wavefunctions of the Hamiltonian for one or more quantum states, with a classical computer.

2. The method of claim 1 wherein representing wavefunctions using a Cartesian component-separated tensor-product further comprises:
representing wavefunctions using a Cartesian component-separated tensor-product on a plane-wave-dual grid.

3. The method of claim 1 wherein representing the Hamiltonian using a Cartesian component-separated tensor-product further comprises:
representing the Hamiltonian using a Cartesian component-separated tensor-product on a plane-wave-dual grid.

4. The method of claim 1 further comprising:
determining the number of qubits required for a commensurate calculation with a quantum computer; and
determining the number of quantum gates required for a commensurate calculation with a quantum computer.

5. The method of claim 1 further comprising:
using the resultant energy eigenvalues to predict an expected output from a commensurate calculation with a quantum computer;
using the resultant eigenstate wavefunctions to predict an expected output from a commensurate calculation with a quantum computer; and
using correlation functions obtained from the eigenstate wavefunctions, to predict an expected output from a commensurate calculation with a quantum computer.

6. The method of claim 1 wherein computing resultant energy eigenvalues and eigenstate wavefunctions of the Hamiltonian for one or more quantum states, with a classical computer, further comprises:
establishing optimal component-separated basis sets.

7. The method of claim 1 wherein computing resultant energy eigenvalues and eigenstate wavefunctions of the Hamiltonian for one or more quantum states, with a classical computer, further comprises:
determining tensor-product Hamiltonian-wavefunction matrix-vector products.

8. The method of claim 1 wherein computing resultant energy eigenvalues and eigenstate wavefunctions of the Hamiltonian for one or more quantum states, with a classical computer, further comprises:
applying (block) Krylov iteration to generate new Krylov vectors.

9. The method of claim 1 wherein computing resultant energy eigenvalues and eigenstate wavefunctions of the Hamiltonian for one or more quantum states, with a classical computer, further comprises:
projecting the Hamiltonian onto the Krylov vectors.

10. The method of claim 1 wherein computing resultant energy eigenvalues and eigenstate wavefunctions of the Hamiltonian for one or more quantum states, with a classical computer, further comprises:
band-pass staging.

11. The method of claim 1 wherein the wavefunctions comprise a Cartesian component-separated tensor product of the form
$$ψ \approx {\sum }_{λ = 1}^{Γ} {X}^{λ} ( {x}_{1} , {x}_{2} , … {x}_{N} ) {Y}^{λ} ( {y}_{1} , {y}_{2} , … {y}_{N} ) {Z}^{λ} ( {z}_{1} , {z}_{2} , … {z}_{N} ) .$$

12. The method of claim 1 wherein the one-particle and two-particle potential energy contributions to the Hamiltonian comprise Cartesian component-separated tensor products of the form
$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$
respectively.

13. A method for performing first-quantized quantum computational chemistry comprising:
establishing the representation of a physical system;
representing the initial wavefunction |ψ(0) [symbol] ;
representing the Hamiltonian using a Cartesian component-separated tensor-product; and
computing the time evolved wavefunction |ψ(t) [symbol] =Û(t)|ψ(0) [symbol] .

14. The method of claim 13 wherein computing the time evolved wavefunction |ψ(t) [symbol] =Û(t)|ψ(0) [symbol] further comprises:
computing resultant energy eigenvalues and eigenstate wavefunctions of the Hamiltonian for one or more quantum states, with a quantum computer.

15. The method of claim 13 wherein:
the representation of the physical system is a plane-wave-dual grid-based representation comprising:
coordinate grid spacing;
minimum and maximum coordinate values; and
a number of grid points.

16. The method of claim 13 wherein the kinetic energy is represented in a plane-wave basis representation, the potential energy is represented in component-separated tensor-product form in a plane-wave-dual grid-based representation, and the initial wavefunction |ψ(0) [symbol] is represented in a plane-wave-dual grid-based representation.

17. The method of claim 13 wherein the one-particle and two-particle potential energy contributions to the Hamiltonian comprise Cartesian component-separated tensor products of the form
$${\hat{V}}_{ext} = {\sum }_{λ = 1}^{Γ ext} {\hat{γ}}_{x}^{λ} ( {x}_{i} ) {\hat{γ}}_{y}^{λ} ( {y}_{i} ) {\hat{γ}}_{z}^{λ} ( {z}_{i} ) and {\hat{V}}_{ee} = {\sum }_{λ = 1}^{{Γ}_{ee}} {\hat{γ}}_{x}^{λ} ( {x}_{i} , {x}_{j} ) {\hat{γ}}_{y}^{λ} ( {y}_{i} , {y}_{j} ) {\hat{γ}}_{z}^{λ} ( {z}_{i} , {z}_{j} ) ,$$
respectively.

18. The method of claim 13 wherein applying the Quantum Phase Estimation algorithm provides a ground state energy level and eigenstate wavefunction.

19. The method of claim 13 wherein applying the Quantum Phase Estimation algorithm provides excited state energy levels and eigenstate wavefunctions.

20. The method of claim 13 wherein computing the time evolved wavefunction |ψ(t) [symbol] =Û(t)|ψ(0) [symbol] further comprises:
applying a sequence of Û(ε)|ψ [symbol] operations with a small time step ε, using the Trotter approximation.

21. The method of claim 20, wherein the one-particle and two-particle potential energy contributions to the Trotter approximation, exp(−iε\hat{V}ₑₓₜ)|ψ₁ [symbol] and exp (−iε\hat{V}ₑₑ)|ψ₁₂ [symbol] , respectively, are implemented using a Cartesian component-separated tensor-product quantum circuit.

22. An apparatus comprising:
quantum hardware, the quantum hardware further comprising a quantum system comprising one or more qubits, and one or more control devices configured to operate the quantum system wherein the apparatus is configured to perform operations comprising:
establishing the representation of a physical system;
representing the initial wavefunction |ψ(0) [symbol] ;
representing the Hamiltonian using a Cartesian component-separated tensor-product; and
computing the time evolved wavefunction |ψ(t) [symbol] =Û(t)|ψ(0) [symbol] .
